(19) United States
(12) Patent Application Publication
(10) Pub. No.: US 2024/0032735 A1
(43) Pub. Date: Feb. 1, 2024

(54) FOOD PORTION CONTROL AND TEMPERATURE SENSING SCOOP

(71) Applicant: Herman Grewal, Grand Rapids, MI (US)

(72) Inventor: Herman Grewal, Grand Rapids, MI (US)

(21) Appl. No.: 18/356,069

(22) Filed: Jul. 20, 2023

Related U.S. Application Data
(60) Provisional application No. 63/369,778, filed on Jul. 29, 2022.

(51) Int. Cl. A47J 43/28; G08B 5/36; A47J 45/06

(52) U.S. Cl. CPC A47J 43/28; G08B 5/36; A47J 45/068

(57) ABSTRACT

A device, a food portion control and temperature sensing scoop is disclosed. The device includes a handle, a color indicator light attached to the handle, and a scoop attached to the handle.

### FIELD OF THE INVENTION

The present invention relates generally to the field of scoops for food and more specifically to the field of scoops for food that control portion by size and weight and sense temperature of the food.

### BACKGROUND OF THE INVENTION

Restaurant operators need for portion sizes of food to be consistent. There is revenue loss due to over portioning. A restaurant loses credibility if food is under portioned or skimped on. Restaurants must maintain record logs of the temperature of food, and consistently monitor to assure that temperatures do not fall into a danger zone. Employees must be trained on these procedures. Traditional scoops are pre-set for specific volumes based on scoop size, assuming the user will level the scoop of food out. Users are inconsistent with levelling the scoop. Weighing the food is more accurate. There is a need for a food portion control and temperature sensing scoop to meet the needs of restaurant operators.

An object of the present invention is to weigh food to ensure portion size.

Another object of the present invention is to take the temperature of foods, and transmit this to a docking station or directly to online storage.

Another object of the present invention is to have a Bluetooth™, Wi-Fi enabled, or wireless transmittable device which will periodically transmit the temperature of food to the docking station or directly to online storage.

Another object of the present invention is to have the desired weight of food be programmable by the user.

Another object of the present invention is to have a recharger docking station that will recharge the scoops and transmit data from the device to online storage.

Another object of the present invention is to have the scoop handle transmit data directly to online storage.

Another object of the present invention is to have removeable scoop attachments that can be replaced with different sizes and shapes of scoops.

Another object of the present invention is to save restaurant owners time and money by consistently portioning food by weight and automatically monitoring temperature of the food.

Another object of the present invention is to produce an alert when the temperature of the food falls into a danger zone.

Another object of the present invention is to be easily washable.

Another object of the present invention is to be waterproof.

Another object of the present invention is to be made of food safe materials.

Another object of the present invention is to provide a means for the user to see if the weight of the food is within a preset range.

Another object of the present invention is to be useable for a wide range of foods, such as dry, wet, warm, hot, and cold foods.

### SUMMARY OF THE INVENTION

A device, a food portion control and temperature sensing scoop is disclosed. The device includes a handle, a color indicator light attached to the handle, and a scoop attached to the handle.

In one embodiment, the handle contains a load cell weight sensor and an infrared thermometer, along with a rechargeable battery. The handle may also contain a means to or configured to periodically transmit data to the docking station or directly to online data storage via Bluetooth™, Wi-Fi, or Radio frequency identification (RFID).

In another embodiment, a docking station may be used to program the scoop to indicate different weights and temperatures. A range of weights can be set by the user and the colored indicator light flashes to indicate that the weight of the food is within the parameters set by the user.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

FIG. 1 is an embodiment of the present invention.

FIG. 2 is an alternative embodiment of the present invention.

FIG. 3 is an alternative embodiment of the present invention.

FIG. 4 is an alternative embodiment of the present invention.

FIG. 5 is a deconstructed view of one embodiment of the present invention showing the inside of the handle.

FIG. 6 is one embodiment of the present invention shown in a recharging docking station.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

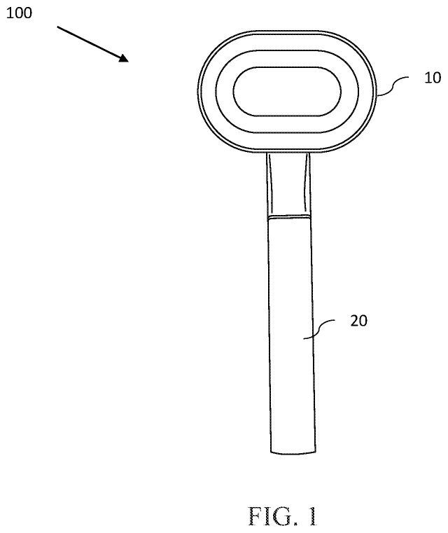

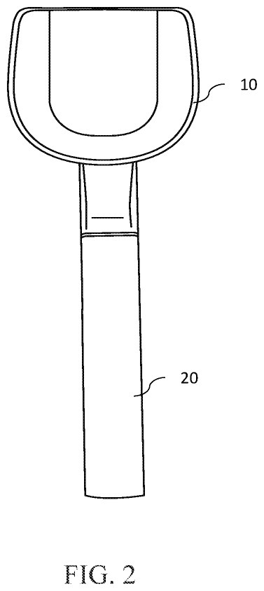

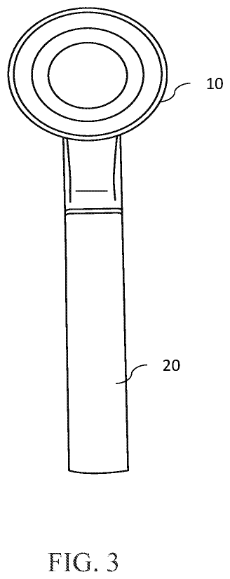

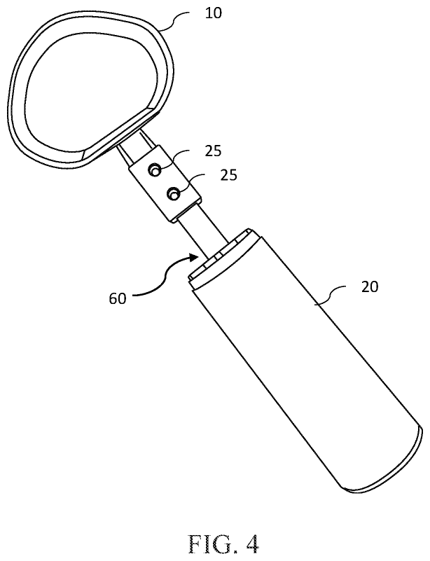

A food portion control and temperature sensing scoop is an interchangeable scoop which fits on a handle which fits into a rechargeable docking station. One example of the interchangeable scoop is shown in FIG. 1, although the scoop portion of the device can also be shaped as shown in FIG. 2, FIG. 3, or FIG. 4 or in any other manner that would be suitable for scooping food.

Food may include proteins, vegetables, grains, or the like. The food may be dry or wet. The temperature of the food may be warm, hot, or cold, programmable by a user. While this invention is targeted at a scoop for food, this does not preclude the scoop being used for any other suitable purpose.

The present invention 100 aims to help restaurant operators to control food costs and maintain food preparation standards and consistency. The scoop 10 allows staff to portion food by precisely weighing ingredients each time the ingredients are served to a customer directly on the service line. The scoop 10 also acts as a thermometer, with an infrared temperature sensor that transmits and monitors food safety temperature data on a regular basis.

The scoop heads 10 can be customized for different sizes and weights and products, from liquids such as pizza sauce to sliced green peppers. It is available in different ounces and shapes for difference portioning and measurement standards.

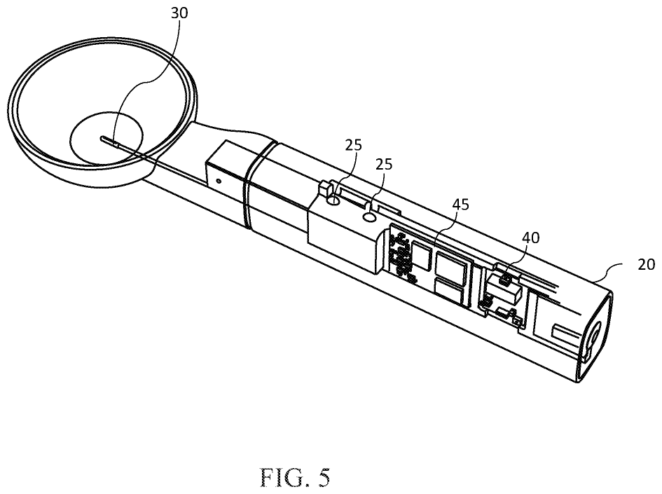

The present invention 100, a device, a food portion control and temperature scoop, as shown in FIGS. 1-6, comprises a handle 20, a color indicator light, and a scoop for scooping food.

The handle 20 may contain one or more communication circuitry 45 connected to various electronic components of the present invention 100.

The communication circuitry 45 may include circuitry for short-haul and long-haul wireless links.

On one embodiment, the handle 20 may contain a load cell weight sensor and an infrared thermometer, along with a rechargeable battery. The handle 20 may also contain a means to or configured to periodically transmit data to the docking station or directly to online data storage via Bluetooth™, Wi-Fi, or Radio frequency identification (RFID).

The docking station 50 may be used to program the scoop 10 to indicate different weights and temperatures. The docking station 50 may include a program that can be any known computer application that allows the user to set a range of weights so that the colored indicator light 25 can flash to indicate that the weight of the food is within the parameters set by the user.

In some embodiments, the program may be configured to conduct trend analysis based on each operator, location or state, country/region. Such a program may provide enhanced data collection, data reports, and other important alerts. Essentially the program may automate the manual data collection process for temperature safety checks within a food service or health environment. The program may be configured to consolidate the reports per user specifications. The program may be accessed remotely to set a new parameter or to review live data.

In an alternative embodiment of the invention, with two color indicator lights 25, as shown in FIG. 4. The handle 20 may be rechargeable or may be powered by batteries.

In one embodiment, an infrared thermometer 30 can be located in a scoop 10.

In some embodiments, a load cell weight sensor in any kind and rechargeable battery can be positioned in the handle 20 of the device 100. A color indicator light 25 can be located in the handle 20 between the handle 20 and the scoop 10.

In some other embodiments, an on/off switch 40 can be placed in the bottom of the handle 20 to control power to the detachable and interchangeable scoop 10. In some other embodiments, a charging port can be located on a back side of the handle 20.

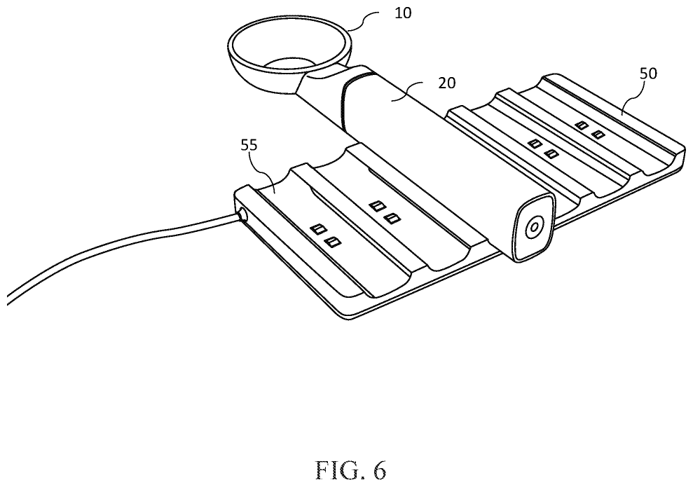

FIG. 6 shows the present invention 100 in a docking station 50 which may include a plurality of adaptive cradles 55. A plurality of handles 20 may be charged at one time by the docking station 50.

In one embodiment, the color indicator light 25 can be on a top side of the handle 20, and a connector 60 connects the handles 20 to their respective scoops 10, as shown in FIG. 4. The connection of the detachable and interchangeable scoop 10 to the handle 20 can be waterproof when the scoop 10 is attached. Alternatively, in some embodiments, the handle 20 may have an LCD screen to display data. The connection of the scoop 10 can include magnetic attachments.

The docking station 55 can be configured to transmit data to an online storage which can be any known online storage. In one embodiment, the handle 20 can be configured to transmit the data to the docking station 50, and the docking station 50 can be configured to transmits data to the online storage where data can be stored and manipulated.

Docking station 50 can be used to charge multiple devices 100. In some embodiments, the device 100 itself will transmit data to the cloud and back end software through wireless transmission.

The docking station 50 can program the present invention 100 to transmit temperature data at pre-set intervals and can notify a user of the event that a temperature is outside of a predetermined safe zone by lighting up the color indicator light 25 on the handle 20, or by any other means such as vibrations, an audible tone or a light on the docking station or an electronic screen.

The docking station 50 can be powered by alternating current (AC) from a standard wall outlet.

The present invention 100 is waterproof and easily washable. Both the scoop portion 10 and the handle portion 20 can be made of food safe materials such as Bisphenol A (BPA) free silicone or other suitable material. The detachable and interchangeable scoop portion 10 may be dishwasher safe. When the detachable and interchangeable scoop 10 is attached to the handle 20, the device 100 can be hand washable and waterproof.

Although the invention has been explained in relation to its preferred embodiment, it is to be understood that many other possible modifications and variations can be made without departing from the spirit and scope of the invention.

What is claimed is:

1. A device comprising:
a handle,
a color indicator light attached to the handle, and
a scoop attached to the handle.

2. The device as claimed in claim 1, wherein the handle contains a load cell weight sensor.

3. The device as claimed in claim 2, wherein the handle contains an infrared thermometer.

4. The device as claimed in claim 1, wherein the handle contains a rechargeable battery.

5. The device as claimed in claim 2, wherein the handle is configured to periodically transmit data to the docking station via Bluetooth.

6. The device as claimed in claim 2, wherein the handle is configured to transmit directly to online data storage via Bluetooth.

7. The device as claimed in claim 4, wherein the handle is configured to periodically transmit data to the docking station via Radio frequency identification (RFID).

8. The device as claimed in claim 1, wherein the handle is configured to transmit data directly to online data storage via BluetoothTM, Wi-Fi, or Radio frequency identification (RFID).

9. A device comprising:
a handle,
a color indicator light attached to the handle,
a scoop attached to the handle, and
a docking station detachably attached to the handle.

10. The device as claimed in claim 9, wherein the docking station is configured to transmit data to an online storage.

11. The device as claimed in claim 10, wherein the handle is configured to transmit the data to the docking station, and the docking station is configured to transmits data to online storage.

12. A device comprising:
a handle,
a color indicator light attached to the handle,
a scoop attached to the handle, and
a docking station detachably attached to the handle, wherein the docking station is configured to transmit data to an online storage.

13. The device as claimed in claim 12, wherein the handle is configured to transmit the data to the docking station, and the docking station is configured to transmit data to online storage.

14. The device as claimed in claim 13, wherein the handle contains a load cell weight sensor.

15. The device as claimed in claim 14, wherein the handle contains an infrared thermometer,

16. The device as claimed in claim 12, wherein the handle contains a rechargeable battery.

17. The device as claimed in claim 14, wherein the handle is configured to periodically transmit data to the docking station via Wi-Fi.

18. The device as claimed in claim 14, wherein the handle is configured to transmit data directly to online data storage via Bluetooth

19. The device as claimed in claim 13, wherein the handle is configured to transmit data directly to online data storage via Wi-Fi

20. The device as claimed in claim 13, wherein the handle is configured to transmit data directly to online data storage via Radio frequency identification (RFID).
